(19) United States
(12) Patent Application Publication
(10) Pub. No.: US 2003/0041013 A1
(43) Pub. Date: Feb. 27, 2003

(54) System and method for configuring goods and services

(76) Inventors: William Grey, Millwood, NY (US); Stuart I. Feldman, Stamford, CT (US); Dailun H. Shi, Croton on Hudson, NY (US); Frederick Yung-Fung Wu, Cos Cob, CT (US); Brian T. Eck, Poughquag, NY (US); Brenda L. Dietrich, Yorktown Heights, NY (US)

Correspondence Address: BUCKLEY, MASCHOFF, TALWALKAR, & ALLISON, 5 ELM STREET, NEW CANAAN, CT, 06840, US

(21) Appl. No.: 09/935,315

(22) Filed: Aug. 22, 2001

(51) Int. Cl. G06F 17/60

(52) U.S. Cl. 705/37

(57) ABSTRACT

A system, method, apparatus, and computer program code for facilitating the sale of an item in an auction involving a plurality of participants includes identifying a bid for the item, the bid made by one of the participants. A desired configuration associated with the bid is then identified. The bid is modified to reflect the desired configuration. A status of the auction is updated based on the modified bid.

### CROSS-REFERENCE TO RELATED APPLICATIONS

This application is related to the following co-pending and commonly assigned U.S. Patent Applications (the content of each of which is hereby incorporated by reference herein for all purposes):

U.S. patent application Ser. No. ______, filed ______(on even date herewith) for “SYSTEM AND METHOD FOR PERSONALIZED DYNAMIC PRICING” (Attorney Docket No. I01.050 and Client Docket No. YOR920010388US1);

U.S. patent application Ser. No. ______, filed ______(on even date herewith) for “SYSTEM AND METHOD FOR CONDUCTING A SELL-SIDE AUCTION” (Attorney Docket No. I01.051 and Client Docket No. YOR920010409US1);

U.S. patent application Ser. No. ______, filed ______(on even date herewith) for “SYSTEM AND METHOD FOR CONDUCTING A BUY-SIDE AUCTION” (Attorney Docket No. I01.052 and Client Docket No. YOR920010410US1);

U.S. patent application Ser. No. ______, filed ______(on even date herewith) for “SYSTEM AND METHOD FOR CONDUCTING A TWO-SIDED AUCTION” (Attorney Docket No. I01.053 and Client Docket No. YOR920010411US1);

U.S. patent application Ser. No. ______, filed ______(on even date herewith) for “SYSTEM AND METHOD FOR ESTABLISHING CUSTOMIZED LEASING TERMS” (Attorney Docket No. I01.054 and Client Docket No. YOR920010412US1); and

U.S. patent application Ser. No. ______, filed ______(on even date herewith) for “SYSTEM AND METHOD FOR FACILITATING TRANSACTIONS AMONG DISPARATE ENTITIES” (Attorney Docket No. I01.055 and Client Docket No. YOR920010413US1).

### FIELD OF THE INVENTION

The present invention generally relates to commerce systems and methods. More particularly, embodiments of the present invention relate to systems and methods for conducting sales of goods and services.

### BACKGROUND OF THE INVENTION

Auctions have proliferated with the advent of the Internet and advances in communication. Many businesses use auctions and marketplaces to buy and sell goods and services and often enjoy great savings and efficiencies as a result. The essential premise of an auction is that prices are determined as a result of competition between bidders for items offered for sale or purchase. These benefits, however, are only realized when more than one bidder is competing for the same item.

A number of different auctions styles and types have developed over the years to encourage different types of competitions among bidders, including, for example: English auctions, Dutch auctions, Japanese auctions, sealed-bid auctions, double auctions, multiple-unit auction, time interval auctions, call auctions, first price auctions, uniform second price auctions, bundle auctions, and multi-attribute auctions.

Many of these types of auctions may be conducted as either one or two-sided auctions. One-sided auctions allow only bids or asks (but not both). One-sided auctions may be run as open or sealed-bid auctions, and as forward or reverse auctions. Two-sided (or double) auctions allow both bids and asks to take place at the same time. The term auction as defined herein shall also include exchanges, which are electronic or online marketplaces that facilitate a many-to-many trading relationship among or between buyers and sellers. Exchanges are commonly referred to by a number of names, including a trading hub, a vortex, an online marketplace, butterfly market, a bid-ask, an e-marketplace, an e-market, an ehub, a net market maker, an eMarket, a vertical marketplace, or a horizontal marketplace. The term auction as defined herein shall also include bulletin boards and other online commerce platforms that facilitate or enable one-to-many or many-to-many trading relationships among or between buyers and sellers. These various types of auctions and marketplaces are generally known in the art.

One type of two-sided auction is the “continuous double auction” where many individual transactions are carried on simultaneously and where trading does not stop when a match occurs. Examples of such auctions are financial or securities exchanges such as intra-day trading on the New York Stock Exchange. Another type of two-sided auction is a call auction, where bids and offers are aggregated, then periodically cleared. Examples of such auctions are the opens at the New York Stock Exchange and periodic calls on the Paris Bourse.

Some auctions and marketplaces are completely automated. In other cases, non-automated entities facilitate, support or otherwise enable marketplace transactions, potentially providing a number of benefits, including increasing market liquidity, and ensuring orderly price movements. For example, “specialists” serve this role on the New York Stock Exchange, and market-makers serve this role on the NASDAQ. As defined herein, auctions include both purely automated marketplaces, and marketplaces in which non-automated entities facilitate, support or otherwise enable marketplace transactions.

A common feature of most of these auctions and marketplaces is that they are generally used to sell or acquire relatively homogeneous goods or services. Without standardization of the goods or services, it is difficult to generate sufficient competition among bidders to achieve the benefits that auctions provide. As a result, auctions are typically not suited for many types of non-standardized goods or services.

Further, auctions are typically not suited for many types of business-to-business environments. Many business-to-business transactions rely on existing relationships between the buyer and the seller. For example, sellers often provide strategic partner discounts to buyers with whom they have a long-standing relationship. Strategic customers expect, and often receive, volume discounts, preferred credit terms, and higher service levels than other customers. Channel partners expect to pay lower prices than their customers. Most existing auctions do not encourage or permit this type of differentiation between participants. Most existing auctions treat all participants as equals. Buyers who purchase in volume pay the same price as buyers who purchase in smaller lots. In fact, buyers who purchase in volume may sometimes pay more than buyers who purchase in smaller lots, since purchases by large buyers may have an impact on the market price of the good or service being transacted, since the size of these purchases results in an imbalance between supply and demand in the market, and may be viewed as a signal regarding future price movements.

Typically, existing auctions treat the bids of strategic, or long-standing customers or suppliers the same as bids from brand new customers or suppliers. It would be desirable to provide an auction and exchange system and method that allows participants to be treated differently, while still allowing these different participants to take part in the same auction.

Existing auctions are also not well-suited to the sale of differentiated or mass-customized products. Such products are often bundled with value-added services or contain a variety of special features and configurations. Items offered for sale or purchase using existing auctions are not typically customizable. Bidders all bid on the same configuration. As a result, because of their specialized nature, items sold at existing auctions may not attract enough interested bidders to generate active bidding. Many buyers and sellers in existing auctions attempt to minimize this problem by compromising and offering standard product configurations. These standard configurations lack differentiation and often sell at lower, commodity prices. Low commodity pricing can lead to price erosion in other channels and for other products, as customers and channel partners in other sales channels begin demanding comparable pricing. It would be desirable to provide a system and method which allows bidders to compete to purchase differentiated or mass-customized products. Further, it would be desirable to allow bidders having particular item configuration requirements to competitively bid against other participants having different item configuration requirements.

A number of auction mechanisms have attempted to address some of these shortcomings. Multi-attribute auctions and exchanges allow bidders to negotiate over the attributes of an item, as well as its price, thus seeking to address the issue of auctioning differentiated goods and services. However, determining the winner of a multi-attribute auction often requires complex analysis, and is not readily transparent to market participants. This makes it difficult for auction participants to understand the bidding process, and may raise concerns about whether the auction is matching bids and offers in an equitable fashion. In addition, multi-attribute auctions often require bidders to specify the relative value they place on different attributes. In many cases, bidders may not know clearly the relative value they place on different attributes, or may have difficulty specifying it. This also creates difficulties for another reason. In many cases it may not be in the bidders' interest to be completely forthcoming about this information, and thus they may withhold or misrepresent this information. Unfortunately, these misrepresentations can distort the auction results.

Combinatorial auctions and combinatorial exchanges allow bidders to negotiate for bundles of items. Typically, bidders specify the relative importance they place on different bundles of items, and the auction performs an optimization to match bids and offers in a fashion that maximizes the benefit to market participants. Unfortunately, combinatorial auctions and exchanges may suffer from similar drawbacks as multi-attribute auctions. They are complex, making it difficult for auction participants to understand and interpret the bidding process and auction results. In addition, they may require bidders to reveal information that they consider private, and may thus be subject to misrepresentations by auction participants.

It would be desirable to provide a system and method that facilitates customization and product differentiation in auction environments, without introducing the complexities, information distortions, and uncertainties of multi-attribute and combinatorial auctions and exchanges. Preferably, the system and method would permit different participants to competitively bid on customizable products and services in a manner that is flexible, yet straightforward. Further, it would be desirable to provide a system and method that allows participants to competitively bid on equitable terms, despite different configuration desires of different participants.

### SUMMARY OF THE INVENTION

Embodiments of the present invention provide a system, method, apparatus, and computer program code for configuring goods and services in auctions.

According to some embodiments of the present invention, a system, method, apparatus, and computer program code for facilitating the sale of an item in an auction involving a plurality of participants includes identifying a bid for the item, the bid made by one of the participants. A desired configuration associated with the bid is then identified. The bid is modified to reflect the desired configuration. A status of the auction is updated based on the modified bid.

According to some embodiments of the present invention, an auction status request is received, and a second desired configuration of the item is identified based at least in part on the auction status request. The second desired configuration is applied to the status to produce a transformed status.

According to some embodiments, the bid is modified by calculating a price differential between the desired configuration and a standard configuration of the item. In some embodiments, the price differential is determined by reference to pricing tables; in other embodiments, the price differential may be determined based on extrinsic pricing data.

Embodiments of the present invention also include a system, method, apparatus, and computer program code for participating in an auction, where the participation includes indicating a preferred configuration of an item offered in the auction, and viewing a status of the auction, where the status is modified based on said preferred configuration. A bid on the item is submitted which is modified based on the preferred configuration.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram of a system pursuant to embodiments of the present invention;

FIG. 2 is a diagram depicting a bid and status process of the system of FIG. 1 according to one embodiment of the invention;

FIG. 3 is a block diagram of one embodiment of the auction administrator device of FIG. 1;

FIG. 4 is a tabular representation of a portion of a participant database according to an embodiment of the present invention;

FIG. 5 is a tabular representation of a portion of an auction database according to an embodiment of the present invention;

FIG. 6 is a tabular representation of a portion of a configuration function database according to an embodiment of the present invention;

FIG. 7 is a tabular representation of a portion of a bid database according to an embodiment of the present invention;

FIG. 8 is a flow diagram depicting a configuration specification process according to one embodiment of the present invention;

FIG. 9 is a flow diagram depicting a bid process according to one embodiment of the present invention; and

FIG. 10 is a flow diagram depicting a transaction process according to one embodiment of the invention.

### DETAILED DESCRIPTION

Applicants have recognized that there is a need for a system, method, apparatus, and computer program code for conducting auctions or competitive exchanges wherein participants having different item configuration desires may competitively bid against each other. The result is a system, method, apparatus, and computer program code which allows sellers to sell differentiated or mass-customized products in a competitive environment, achieving increased sales, prices and item liquidity for the seller. Buyers also benefit in that they will be able to acquire a greater number and type of items by auction, allowing the purchase of items in increased volume and perhaps at reduced prices. Further benefits and advantages of embodiments of the present invention will become apparent upon reading the following description.

A number of terms are used herein to describe features of embodiments of the present invention. As used herein, the term “auction” will be used to refer to any of a number of formats (known and to be developed) for selling goods or services in a competitive bidding environment. As used herein, the term “auction” may be used to refer to the set of activities that take place to solicit, receive, analyze, and respond to bids for a particular item or items. A number of different auctions may take place at any given time. Each auction involves the interaction of several entities, including at least one buyer, at least one seller, and an auction administrator. In some embodiments, one or more service providers may be involved in an auction, acting on behalf of one or more buyers, sellers, and/or administrators.

As will be described, embodiments of the present invention may be used with a number of different types of auctions, including, for example, those auctions referred to as: English auctions, Dutch auctions, Japanese auctions, sealed-bid auctions, double auctions, multiple-unit auctions, time interval auctions, call auctions, first price auctions, uniform second price auctions, bundle auctions, combinatorial auctions, and multi-attribute auctions. Embodiments of the present invention may also be used with other types of exchanges and marketplaces known in the art.

As used herein, the term “bid” (or the term “submission”) will be used to refer to an offer to purchase or an offer to sell (depending on the type of auction in which the bid is made) received from an auction participant. For the purposes of this disclosure, the term “bidder” will be used to refer to the party submitting a bid. A buyer or a seller (both of which are defined further below) may be a bidder, depending on the type of auction. A bid may include one or more terms of the bid, such as a price term, a quantity term, a configuration term, a delivery term, or the like. The bid may involve an actual purchase or transfer, a contingent purchase or transfer, the purchase or transfer of certain rights, and other types of commercial and non-commercial transactions known in the art.

As used herein, the term “buyer” may be used to refer to a party submitting a bid (an offer to purchase) on an item in an auction. For example, the buyer may be a prospective buyer, submitting an offer to purchase or acquire an item offered in an auction. For the purposes of this disclosure, the term “buyer” refers to prospective buyers as well as the actual purchasers of item(s) by auction. A buyer could also be a human agent representing a prospective buyer, or an intelligent software agent such as a shopping “bot” representing a prospective buyer.

As used herein, the term “seller” may be used to refer to the party offering to sell or provide an item in an auction. For example, the seller may be a prospective seller, submitting a bid (an offer to sell or distribute) on an item offered in an auction. For the purposes of this disclosure, the term “seller” refers to prospective sellers as well as the actual seller of item(s) by auction. A seller could also be a human agent representing a prospective seller, or an intelligent software agent such as a shopping “bot” representing a prospective seller. Both “buyers” and “sellers” will be referred to as “participants” in the auction.

As used herein, the phrase “winning bid” will be used to refer to the bid (either an offer to purchase, an offer to sell, or either an offer to sell or an offer to purchase, depending on the type of auction) which, at the close of the auction, results in the winning participant acquiring the right (or obligation) to purchase or sell the item offered in the auction. Depending on the type of auction, the “winning bid” may not necessarily be the highest priced bid (e.g., in a Dutch auction, the winning bid may be at a lower price than earlier bids). Depending on the type of the auction, there may be multiple “winning bids”. As used herein, the phrase “current best bid” will be used to refer to any bid which, during the conduct of the auction, would be the “winning bid” if the auction were to close without consideration of further bids.

As used herein, the term “administrator” will be used to refer to an entity operating as the coordinator, organizer or facilitator of an auction or exchange. The administrator may be an independent entity operating a commercial auction or exchange, or the administrator may be operating on behalf of a seller or buyer to conduct a closed or private auction with a limited number of participants. The administrator may also be operating on behalf of a seller or buyer to conduct a public auction with a broad range of participants. In embodiments described herein, the administrator will be described as the entity controlling the resources used to solicit information (e.g., bids, auction status data, and transformation data). In some embodiments, the administrator may be an independent entity. In other embodiments, the administrator may be an affiliate of one or more participants in the auction, and/or an affiliate of one or more service providers. In other embodiments, the administrator may be a participant in the auction, or a service provider, or an entity partially or entirely owned or controlled by one or more participants in the auction, or by one or more service providers.

As used herein, the term “service provider” will be used to refer to an entity that provides value-added services such as logistics support, fulfillment, financing, or transaction settlement services that facilitate conducting transactions in an auction or exchange. The service provider may be an independent entity providing services, an entity operating on behalf of an auction administrator, or an entity operating on behalf of a participant (e.g., a buyer or seller) in an auction. In some embodiments, the service provider may be an entity controlling resources used to solicit information (e.g., information used to develop configuration functions or other information used in conjunction with embodiments of the present invention).

As used herein, the term “item” may be used to refer to any of a number of different types of goods or services that may be purchased or sold in an auction or exchange format. As an illustrative example, items that may be purchased or sold using techniques of the present invention may include: differentiated goods, commodities, factor inputs, components, systems, subsystems, devices, raw materials, manufactured products, services, options to purchase goods or services, financial instruments, claims on assets, contingent claims on assets, or the like. An “item” may be an individual component, device or service. An “item” may also be a grouping of individual components, devices or services (sometimes referred to herein and in the art as a “lot” or as a “bundle”). An “item” may also be an assemblage of components and/or services into a system (sometimes referred to herein and in the art as a “configuration”).

### System

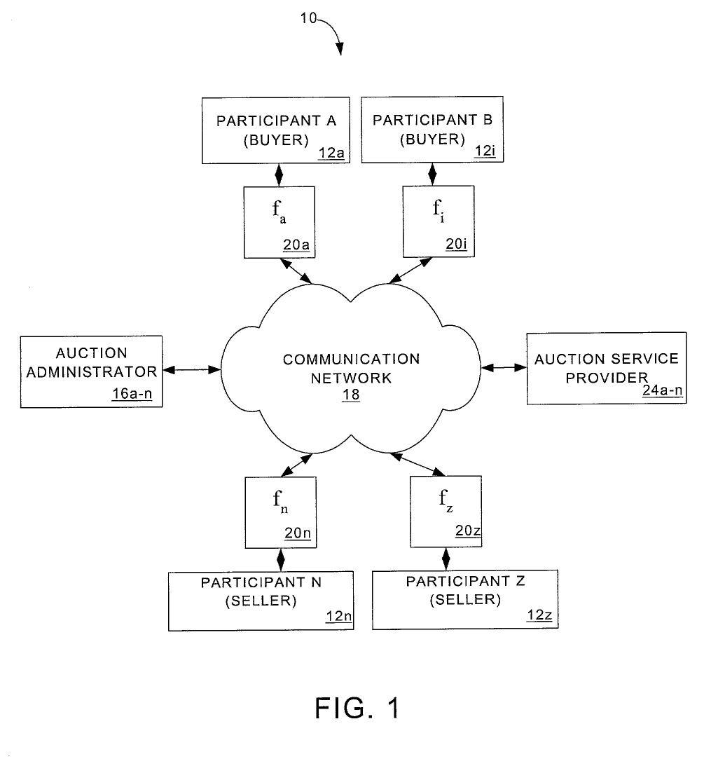

Referring first to FIG. 1, an auction system 10 according to embodiments of the present invention is shown. As shown in FIG. 1, auction system 10 includes a number of participants operating participant devices 12. The participants may include one or more individuals or entities acting as buyers in an auction (and operating buyer devices 12a-i) and who submit offers to purchase items posted for sale or purchase in the auction. The participants also include one or more individuals or entities acting as sellers in an auction (and operating seller devices 12n-z) and who submit offers to sell items in an auction. One or more auction administrators operating auction administrator devices 16a-n may be employed to administer auctions employing features of the present invention. One or more auction service providers operating auction service provider devices 24a-n may be employed to provide value-added services supporting an auction conducted in auction system 10.

Each of these parties may communicate and participate in auctions pursuant to the invention via a communication network 18. Each of the parties, in one embodiment, operates computing devices in communication with communication network 18. These devices will be described further below. For the purpose of describing features of the invention, the party (e.g., the auction administrator) and the device operated by that party (e.g., an auction administrator computing device) may be referred to as either the party or the device (e.g., “participant 12” may also be referred to as “participant device 12”).

In one embodiment of the present invention, an auction utilizing features of the present invention involves one auction administrator operating auction administrator device 16 which is configured as a Web-based server device accessible to participants 12a-z (including participants acting as buyers as well as participants acting as sellers) via the Internet. As will be described further below, the auction operated by the auction administrator via auction administrator device 16 may be any of a number of different types. Participation by buyers and sellers will vary based on the type of auction. For example, in a sell-side auction, a plurality of buyers operating buyer devices 12a-i will interact with an auction administrator operating auction administrator device 16 to submit offers to purchase items posted by one or more sellers operating seller devices 12n-z. In a buy-side auction, a plurality of seller devices 12n-z will interact with auction administrator device 16 to present offers to sell items requested by one or more buyers via buyer devices 12a-i. Other auction or exchange types will involve other forms of interaction known in the art.

Pursuant to one embodiment of the present invention, one or more participants may be associated with one or more configuration functions 20. As will be described further below, these configuration functions 20 are used to modify, adapt, translate or otherwise apply configuration rules and preferences in an auction. Other functions may also be applied to information in the auction. For example, other functions (referred to as “transformation functions”) are described in the above-referenced copending and commonly-assigned U.S. patent application Ser. Nos. ______, _____, ______,______, ______, ______, (Atty Docket Nos. I01.050, I01.051, I01.052, I01.053, I01.054, I01.055, respectively).

According to embodiments of the present invention, some participants in an auction are associated with one or more configuration functions 20. As man example, a participant such as Participant A (Buyer 12a in FIG. 1) may have an associated configuration function 20a which modifies some or all of the bids submitted by Participant A. For example, configuration function 20a may be a preferred computer configuration (e.g., all laptop computers purchased by Participant A should be configured with Microsoft® Windows 2000® operating system, a 20 GB hard drive, and an internal CD R/W drive) applied to all bids submitted by Participant A in auctions in which Participant A is making a bid to purchase a computer. Other participants may have different configuration functions associated with them. For example, Participant B (Buyer 12b in FIG. 1), acting as a buyer in the same auction as Participant A may be associated with a different configuration function 20b that automatically applies a different configuration preference to Participant B's bid (e.g., all laptop computers purchased by Participant B should be configured with Microsoft® Windows Millenium Edition® operating system, a 30 GB hard drive, and an internal 3.5″ floppy drive). As a result, both Participant A and Participant B may participate in the same auction, even though each desires to purchase differently-configured items.

In this manner, the seller of the item in the auction is able to receive better pricing on items. Further, unlike prior auctions, embodiments of the present invention enable the seller to sell non-standardized items in an auction format. For example, it is believed that in previous auctions, the seller in the example set forth above would be unable to offer differently-configured laptop computers because the seller was unable to know in advance which features would be bid on by participants in the auction. As a result, sellers in previous auctions often picked a small set of differently-configured items and offered each configuration for sale, hoping to attract sufficient bidders for each configuration. Embodiments of the present invention allow sellers to offer items for sale which are configured based on bids received at auction, while encouraging competitive bidding among different participants having different configuration needs.

In some embodiments, configuration functions 20 may also be used to modify, adapt, translate or otherwise transform information that is transmitted from auction administrator device 16 to one or more participant devices 12. For example, Participant D may view the status of an auction after the status has been modified by a configuration function associated with Participant D. As an example, Participant D may desire to only purchase laptop computers configured with Microsoft® Windows 2000® operating system, a 10 GB hard drive, an internal DVD drive, and a 1.0 GHz Intel® Pentium IV processor. That is, Participant D will see the current auction pricing based on Participant D's preferred configuration (which may be a different price than the price seen by Participant A or other participants).

Each of the parties operating devices 12, 16 or 24 may communicate via communication network 18, which may be any of a number of different types of commonly-used networks, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology.

Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system.

Participant devices 12a-z, auction administrator devices 16a-n and auction service provider devices 24a-n may be any devices capable of performing the various functions described herein. In one embodiment, auction administrator devices 16a-n and auction service provider devices 24a-n are configured as Web-based server devices, and participant devices 12a-z are configured as general purpose computing devices. In general, participant devices 12, auction administrator devices 16 and auction service provider devices 24 may be computing devices such as: a Personal Computer (PC), a portable computing device such as a Personal Digital Assistant (PDA), a wired or wireless telephone, a one-way or two-way pager, a kiosk, an interactive television device, or any other appropriate storage and/or communication device.

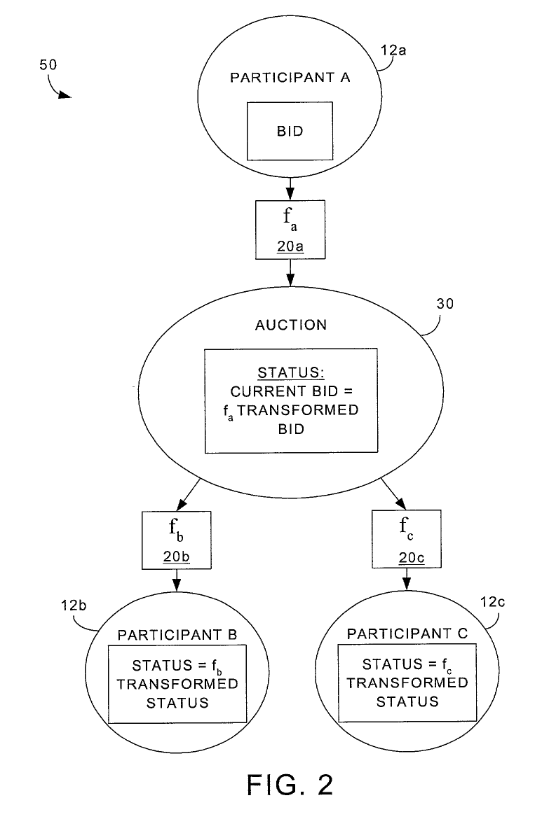

Referring now to FIG. 2, a bid and status process 50 pursuant to embodiments of the present invention is shown. Process 50 will be described to illustrate certain features of embodiments of the present invention. Further details of embodiments of the present invention will be provided below. Process 50 involves interaction between a number of different participants in an auction, referred to here as Participant A, Participant B, and Participant C. As an example, process 50 involves different participants competitively bidding on laptop computers offered for sale by a seller in an auction operated pursuant to embodiments of the present invention. Each of the participants (A, B, and C) have registered to participate in the auction (in a process which will be described further below) and have established at least one configuration function identifying their configuration preferences.

For example, Participant A may have established a configuration preference for a bare-bones laptop system having no special features (e.g., the base laptop configuration may be defined by the auction administrator 16 as a laptop having an 800 MHz processor, a 10 GB hard drive, and a 8×CD ROM drive). This configuration preference may be indicated by Participant A during, for example, an auction registration process and may result in the generation of a configuration function 20a associated with Participant A.

Participant B may indicate a preference for a customized version of the laptop, including a 1.0 GHz processor, a 30 GB internal hard drive, and a CD/RW drive. These configuration preferences are stored as a configuration function 20b associated with Participant B. Participant C may also prefer a customized version of the standard laptop, and may specify preferences such as a larger display and a longer-life battery. These preferences may be specified in a configuration function 20c associated with Participant C.

In the depicted process, Participant A is participating as a buyer in an auction and submits a bid (in this example, the bid is an offer to purchase) to purchase a laptop computer in the auction. This bid may be, for example, submitted to an auction administrator (not shown) running the auction. The bid is transformed by configuration function 20a. In one embodiment, configuration function 20a is applied by software residing at the participant device 12a operated by Participant A. In another embodiment, it may be applied by software residing at auction administrator device 16. In another embodiment, configuration function 20a may be applied by software residing at an auction service provider device (e.g., item 24 of FIG. 1). In yet other embodiments, the function may be applied by software residing at a seller device (e.g., item 12n-z of FIG. 1). Other techniques for enforcing and applying configuration functions may also be used.

Upon receipt of the bid from Participant A, configuration function 20a is identified and is used to modify the bid, generating a transformed bid reflecting Participant A's configuration preferences. The dollar amount of Participant A's bid may be, for example, modified based on its customization preferences. For example, if Participant A bid $1,000 for a laptop, the configuration preferences identified in configuration function 20a may be used by auction administrator device 16 to generate a transformed bid reflecting the cost of the customized configuration (e.g., by reference to a price schedule indicating price adjustments for each of the desired features). Auction administrator device 16 may then compute a transformed bid price associated with the custom configuration and based on the customer's submitted offer amount. In the example, Participant A has indicated a preference for the standard, bare-bones configuration of the computer. As a result, the $1,000 bid will not be adjusted based on configuration function 20a. When Participant A then views the status of the auction, he will see that the current high bid of the auction is $1,000 for a laptop.

According to some embodiments of the present invention, Participant B will see a different auction status. In this example, if Participant B submits a request to view the status of the auction, his status request will be associated with Participant B's configuration function 20b and the current price of the laptop will be transformed based on configuration function 20b. In the example, the price will likely be higher, as Participant B has requested a customized version of the laptop. In one embodiment, auction administrator device 16, upon receipt of Participant B's status request, will identify the associated configuration function 20b, and perform a price look-up to determine the additional (or lesser) cost of the features requested by Participant 20b. The total cost, from a base of $1,000, will be computed and presented to Participant B as the current status of the auction. For example, assuming that the additional features requested by Participant B are equal to an additional $250, Participant B will be informed that the current high bid for the laptop is $1,250 (the value of the current base bid plus the customized features requested by Participant B). Participant B may then choose to submit a bid if he so desires.

Participant C may undertake similar interactions, each of which will be transformed by the configuration function 20c associated with Participant C. The result is a system that allows multiple participants having different configuration needs to participate in the same auction or exchange. Participant's special configuration needs are automatically applied to their bids and to their viewing of the status of the auction. Further details and benefits of embodiments of the present invention will be described below. A description of one embodiment of an auction administrator device will first be described, along with a discussion of data stored at or accessible to the device pursuant to embodiments of the present invention.

### Devices

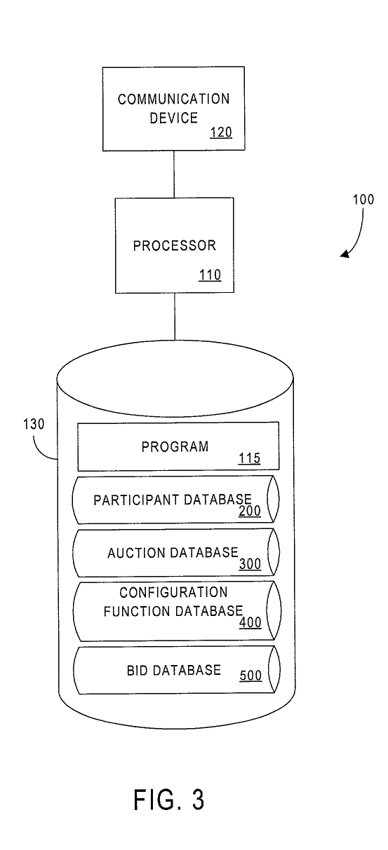

FIG. 3 illustrates an embodiment of an auction administrator device 100 which may be operated by an auction administrator in the system of FIG. 1. Auction administrator device 100 may be used in embodiments where an auction administrator is used to administer and conduct an auction pursuant to the invention. In other embodiments, a buyer, a seller, an auction service provider or other entity may participate in the administration of the auction.

Administrator device 100 may be implemented as a system controller, a dedicated hardware circuit, an appropriately programmed general purpose computer, or any other equivalent electronic, mechanical or electro-mechanical device. Administrator device 100 comprises a processor 110, which may be any of a number of suitable processing devices, such as one or more Intel® Pentium® processors. Processor 110 is coupled to a communication device 120 through which processor 110 communicates with other devices, such as, for example, one or more participant devices 12 operated by buyers and/or sellers participating in the auction, and auction service provider devices 24 operated by auction service providers providing value-added services in support of an auction (each of which devices may also be implemented as general purpose computer or other equivalent electronic, mechanical, or electro-mechanical device).

Communication device 120 may include hardware and software to facilitate communication with other devices using wired or wireless techniques, or a combination of different techniques. For example, communication device 120 may be one or more of: a network adapter, a modem, a Bluetooth device, etc. In one embodiment, communication device 120 facilitates communication with other devices over a network such as the Internet. Processor 110 may also be in communication with one or more input and output devices (not shown) as are known in the art (such as, for example, a keyboard, mouse, microphone, monitor, printer, etc.).

Processor 110 is also in communication with a data storage device 130. Data storage device 130 comprises an appropriate combination of magnetic, optical and/or semiconductor memory, and may include, for example, Random Access Memory (RAM), Read-Only Memory (ROM), a compact disc and/or a hard disk. Processor 110 and data storage device 130 may each be, for example: (i) located entirely within a single computer or other computing device; or (ii) connected to each other by a remote communication medium, such as a serial port cable, telephone line or radio frequency transceiver. In one embodiment, administrator device 100 may comprise one or more computers that are connected to a remote server computer for maintaining databases.

Data storage device 130 stores a program 115 for controlling processor 110. Processor 110 performs instructions of program 115, and thereby operates in accordance with the present invention, and particularly in accordance with the methods described in detail herein. Program 115 may be stored in a compressed, uncompiled and/or encrypted format. Program 115 furthermore includes program elements that may be necessary for allowing processor 110 to interface with computer peripheral devices, such as an operating system, a database management system and “device drivers”. Appropriate program elements are known to those skilled in the art, and need not be described in detail herein.

According to an embodiment of the present invention, the instructions of program 115 may be read into a main memory from another computer-readable medium, such as from a ROM to RAM. Execution of sequences of the instructions in program 115 causes processor 110 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Data storage device 130 also stores (i) a participant database 200, (ii) an auction database 300, (iii) a configuration function database 400, and (iv) a bid database 500. These databases are described in detail below and depicted with exemplary entries in the accompanying figures.

### Databases

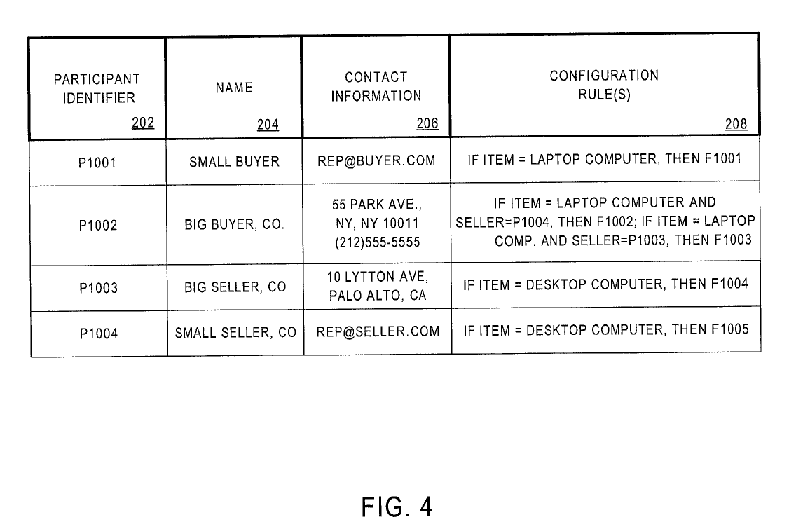

Each of the databases referred to in FIG. 3 will now be described by referring to FIGS. 4-7. While the databases are shown as being stored at, or accessible by, administrator device 100, portions of or all of the data in one or more of the databases may be stored at or accessible to other devices in the system. For example, in some embodiments, configuration functions may be stored at (or accessible to) devices operated by other participants in an auction, such as devices operated by buyers, sellers, or service providers.

As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

### Participant Database

Referring to FIG. 4, a table is shown representing a participant database 200 that may be stored at, or accessible by, auction administrator device 100 according to an embodiment of the present invention. The table includes entries identifying a number of different entities and/or individuals that have been identified as participating in an auction pursuant to the present invention. Participants identified in participant database 200 may include parties acting as buyers in an auction as well as parties acting as sellers in an auction. This information may be stored in database 200 when a participant registers for participation in one or more auctions.

The table shown in FIG. 4 defines a number of fields 202-208 for each of the entries. In the embodiment depicted, the fields specify: a participant identifier 202, a name 204, contact information 206, and configuration rule(s) 208. Other fields and combinations of fields may also be used to provide and access information about different participants in an auction and their associated configuration functions.

Participant identifier 202 may be, for example, an alphanumeric code or other information that is associated with and used to identify a participant who has registered to participate in one or more auctions pursuant to embodiments of the present invention. Participant identifier 202 may be generated by, for example, auction administrator device 100 (FIG. 3) or it may be provided by a participant. The participant's individual or company name may be provided in name 204, while information used to contact the participant may be provided in contact information 206.

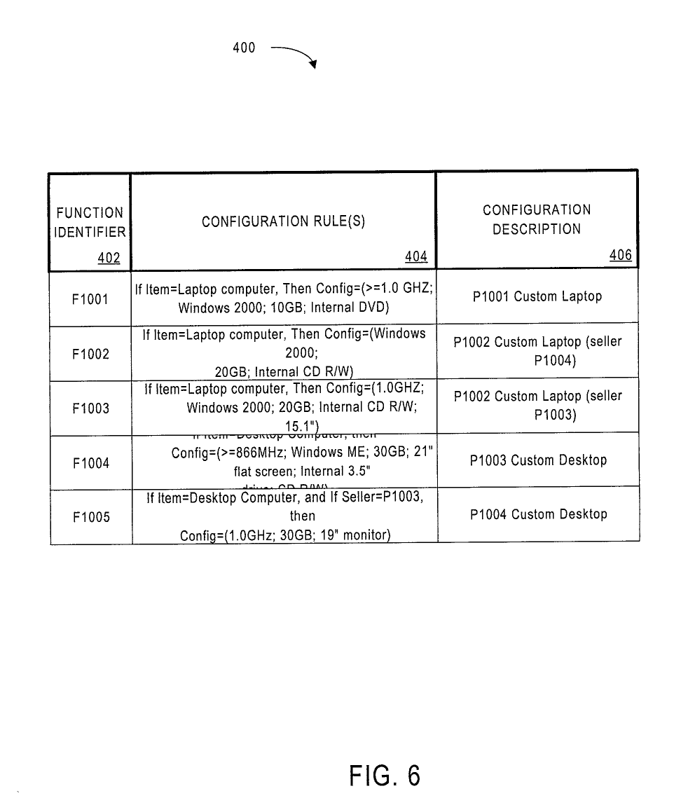

Configuration rule(s) 208 may be, for example, information identifying circumstances in which one or more configuration functions associated with the participant may be applied. Individual configuration functions may be identified by reference to one or more function identifiers (defined in configuration function database 400 described below in conjunction with FIG. 6). Any of a number of different configuration functions may be referenced. Further, any of a number of different rules for applying the configuration functions for a particular participant may also be provided.

For example, in some embodiments, the application of a particular configuration function will depend on the identity of the seller (e.g., the party offering to sell items via auction). For example, a buyer may wish to purchase a certain configuration of an item from a first seller, and an entirely different configuration from a second seller. As another example, in some embodiments, the application of a particular configuration function will depend on the identity of both the seller (e.g., the party offering to sell items via auction) and the buyer (e.g., the party offering to buy items via auction).

As another example, in some embodiments, the application of a particular configuration function will depend on the identity of both the seller (e.g., the party offering to sell items via auction) and the nature or identity of the item posted for sale or purchase via the auction. As yet another example, in some embodiments, the application of a particular configuration function will depend on the nature or identity of the item posted for sale or purchase via the auction.

In the example table illustrated in FIG. 4, each of the four depicted participants has established one or more configuration rule(s), which are stored at 208. The configuration rule(s) 208 specify desired configurations of items that may be purchased or bid upon by each of the participants. For example, participants P1001 and P1002 have established rules indicating preferred laptop computer configurations (the configuration information is stored at configuration function database 400, described below in conjunction with FIG. 6). Participants P1003 and P1004 have established rules indicating preferred desktop computer configurations. Those skilled in the art will recognize that other types of rules may also be established and applied using techniques of embodiments of the present invention.

In the table depicted in FIG. 4, participant information is stored in participant database 200, which is stored at or accessible by auction administrator device 100. In other embodiments, participant information (or some portion thereof), may be stored at other locations, such as a database stored at or accessible to participant device 12 or auction service provider device 24 (FIG. 1). In such embodiments, participant information may be requested from the device that is storing or has access to the information, or it may be requested by other devices in the system.

### Auction Database

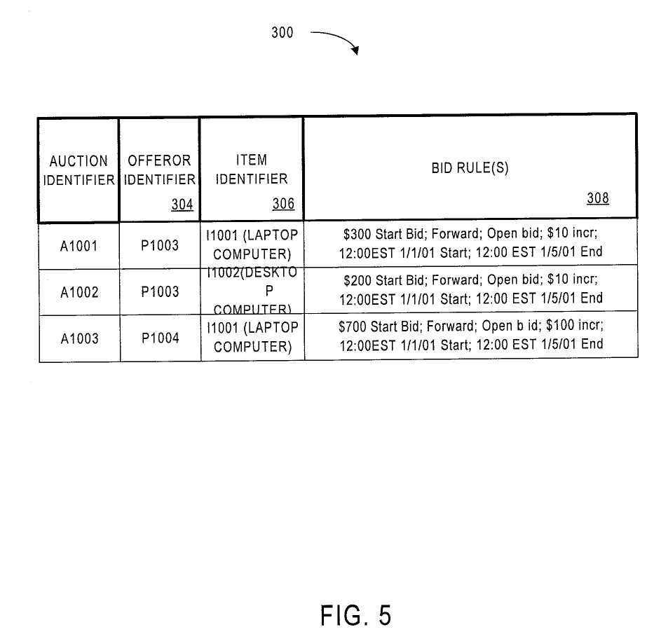

Referring now to FIG. 5, a table is shown representing an auction database 300 that may be stored at, or accessible to, auction administrator device 100 (FIG. 3) according to an embodiment of the present invention. The table includes a number of entries identifying one or more auctions that are operated by the auction administrator. The table also defines fields 302-308 for each of the entries. The fields specify information used to identify each of the auctions administered by the auction administrator, including for example: an auction identifier 302, a seller identifier 304, an item identifier 306, and one or more bid rule(s) 308. The information in auction database 300 may be created and updated, for example, when an auction administrator establishes an auction using features of embodiments of the present invention. This information may be entered by an auction administrator operating auction administrator device 100. In some embodiments, the information may also be entered by other parties, such as a participant operating participant device 12, or a service provider operating auction service provider device 24 (FIG. 1).

Auction identifier 302 may be, for example, an alphanumeric code associated with an auction administered by an auction administrator. Auction identifier 302 may be generated by, for example, auction administrator device 100.

Offeror identifier 304 may be, for example, the same as or related to participant identifier 202 of participant database 200. Offeror identifier 304 identifies the party in the auction identified by auction identifier 302 who is soliciting bids on an item. For example, in a sell-side auction, the offeror identifier 304 identifies a participant who has posted an item for sale via the auction identified by auction identifier 302. In a buy-side auction, on the other hand, the offeror identifier 304 identifies a participant interested in purchasing an item or items, and is soliciting bids from prospective sellers via the auction identified by auction identifier 302.

In some embodiments, offeror identifier 304 may identify an offeror that does not have a participant identifier (from participant database 200). In such cases, additional information identifying the offeror may be provided, for example, in auction database 300.

Item identifier 306 may be, for example, information identifying one or more items for which bids are being solicited in the auction identified by auction identifier 302. The information may include, for example, a product code such as a Universal Product Code (UPC) or other information particularly identifying the item(s). In the depicted embodiment, item identifier 306 simply includes an alphanumeric designator along with a brief description of the item. In other embodiments, further details of offered items may be specified to precisely identify items offered by auction. These details could include descriptions of product or service characteristics, images depicting a product or service, information about the manufacturer or provider of a product or service, information about delivery terms associated with a product or service, links to web pages with further information about the product or services, links to web pages with further information about the manufacturer or provider of a product or service, etc.

Bid rule(s) 308 may include information identifying one or more rules that govern the bidding process of the auction identified by auction identifier 302. For example, bid rule(s) 308 may include rules specifying a starting bid for the item, whether the auction is a forward or a reverse auction, whether the auction is public or private, whether bidding will be anonymous or not, the type of auction (e.g., open cry, sealed-bid, Dutch, English, etc.), a minimum bid increment, a start time, an end time, a reserve price, etc. In some cases, these rules may specify other databases or database fields with further information required to process the rule. For example, if a rule specifies that an auction is a private auction, it might include a reference to another database specifying qualified participants in the private auction. Other rules necessary to govern the conduct of the auction identified by auction identifier 302 may also be provided in bid rule(s) 308.

In the example data shown in FIG. 5, one seller (participant identifier P1003) is soliciting bids in two different auctions. In one auction, A1001, the seller is soliciting bids on laptop computers. In another auction, A1002 the seller is soliciting bids on desktop computers. A second seller, P1004, is soliciting bids on laptop computers in a third auction, A1003. Each of the example auctions are forward open cry auctions, with established starting bids and bid increments. Each auction also has specified starting and ending times. Those skilled in the art will recognize that other information may also be provided to further specify auction rules, items, and procedures.

Configuration Function Database Referring to FIG. 6, a table represents a configuration function database 400 that may be stored at (or accessible to) auction administrator device 100 (FIG. 3) according to an embodiment of the present invention. The table includes a number of entries identifying different configuration functions that may be applied to information in auctions operated pursuant to embodiments of the present invention. The table also defines a number of fields 402-406 for each of the entries. The fields specify: a function identifier 402, configuration rule(s) 404, and a configuration description 406. The information in configuration function database 400 may be created and updated, for example, by an auction administrator based on information received from individual participants in an auction.

Function identifier 402 may be, for example, an alphanumeric code associated with a particular configuration function that may be used in an auction operated pursuant to embodiments of the present invention. A number of different function identifiers 402 may be established for use in an auction.

Configuration rule(s) 404 may be, for example, information identifying one or more rules that are applied when the configuration function identified by function identifier 402 is used. Configuration rule(s) 404 may include any of a number of different types of rules that apply item configuration preferences established by or on behalf of one or more participants in an auction. Examples of different types of configuration rule(s) 404 which may be applied using embodiments of the present invention include rules which are specified by a participant for a particular auction (e.g., in an auction for laptop computers, participants may specify a desired configuration for that particular auction). Other rules may be established by a participant for use in a number of auctions (e.g., a participant may specify a desired configuration for all laptops that it purchases in any auction). Yet other rules may be established by the seller, or jointly by the seller and the buyer.

Some rules may be established based on data such as, for example: the cost of the item(s); components or raw materials costs; finished goods inventory levels; component or raw materials inventory levels; work in process inventory levels; projected demand; projected volatility in demand; projected supply; projected volatility in supply; available capacity; projected capacity utilization; production pipeline; customer elasticity of demand; demand correlations for different item configurations; etc. Some or all of this information may also be used to establish a price for a particular configuration established for a buyer. Other rules may be established which are applied based on one or more product or service quality attributes. Embodiments of the present invention may also be used to specify desired configurations of services sold at auction, desired configurations of bundles of goods, desired configurations of bundles of goods and services, etc. Those skilled in the art will recognize that a variety of different types of configuration rules may be established and applied using techniques of embodiments of the present invention.

In the example data shown in FIG. 6, buyers have specified desired configurations for particular types of items sold at auction (three rules are shown for laptop computers and two rules are shown for desktop computers).

Configuration rule(s) 404 may be expressed in any of a number of different functional forms, including, for example, in the form of a functional model, with associated model parameters. In such embodiments, entries in configuration function database 400 may include a transformation rule 404 describing the functional form of the configuration function, accompanied by at least one parameter associated with the transformational form.

Configuration rule(s) 404 may include rules establishing that a certain configuration preference be applied only if certain conditions are met. For example, some configuration functions may be specifically established for application in a particular auction, or for auctions conducted by a particular seller, or for particular goods or services. Other configuration functions may only be applied if the bid amount or other terms of the bid meet specified criteria (e.g., a buyer may wish to apply particular configuration rules based on the price or quantity of items being bid upon). Those skilled in the art, upon reading this disclosure, will recognize that a number of other different types and combinations of configuration rule(s) 404 may be applied using features of the present invention.

Configuration description 406 may be, for example, information describing the configuration function identified by function identifier 402. Further, information at 406 could include information to be displayed to participants of the auction during the auction.

### Bid Database

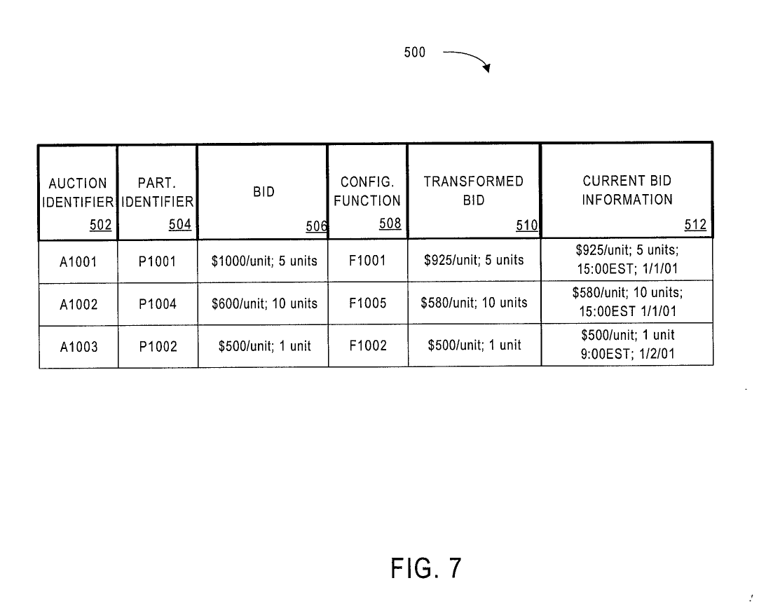

Referring now to FIG. 7, a table is shown which represents a bid database 500 that may be stored at, or accessible by, auction administrator device 100 according to an embodiment of the present invention. The table includes a number of entries identifying bids that have been received in auctions administered by an auction administrator operating auction administrator device 100. For clarity of exposition, only a few exemplary bids are illustrated in the table shown in FIG. 7. As described in the definitions set forth above, “bids” as used herein may refer to either offers to purchase or offers to sell (depending on the type of auction operated), therefore, bid database 500 may record information about offers to sell (e.g., in the case of a buy-side auction), offers to purchase (e.g., in the case of a sell-side auction), or both offers to purchase and offers to sell (e.g., in the case of a two-sided auction).

The table also defines a number of fields 502-512 for each of the entries. The fields specify: an auction identifier 502, a participant identifier 504, a bid 506, a configuration function 508, a transformed bid 510, and current bid information 512. The information in bid database 500 may be created and updated, for example, each time auction administrator 16 receives a bid from a participant in an auction being operated by auction administrator 16. Some or all of the information stored in bid database 500 may be received via communication network 18 in any of a number of different formats. For example, bids (and other information transmitted pursuant to the invention) may be submitted by (or to) participants 12 via electronic data interchange (EDI) messages, via Extensible Markup Language (XML) messages, via instant messaging, via electronic mail, via Web-based forms, via telephone or facsimile, telex, etc.

Auction identifier 502 may be, for example, based on or identical to auction identifier 302 of auction database 300, and is used to associate a particular bid with a particular auction. Each auction identified by an auction identifier 502 may have a number of entries representing individual bids received for that auction. In the table shown in FIG. 7, only the current best bid in each auction is shown. However, other bids and offers, including a previous best bid or bids, or current bids that are not the current best bid, could also be recorded in bid database 500. For example, in a continuous two-sided auction, a buyer may place a bid that at the time of the bid may not be the current best bid, but which may become the current best bid as market conditions change over time.

Participant identifier 504 may be, for example, based on or identical to a participant identifier 202 of participant database 200 and is used to identify a particular participant (such as a buyer or seller) in an auction. Each participant in an auction may submit multiple bids and, therefore, bid database 500 may contain multiple entries for a participant in a particular auction. In the example data depicted in FIG. 7, bid data is shown for three different participants (buyers P1001, P1004, and P1002) bidding in three different auctions (auctions A1001, A1002 and A1003).

Bid 506, may be, for example, information identifying a particular bid made by a participating buyer or seller. In the embodiment depicted, only information reflecting the current best bid in each auction is depicted. In some embodiments, data will also be stored indicating the bid history of the auction, including all bids received (whether or not a bid is the current best bid or not). The information in bid 506, in one embodiment, reflects non-transformed bid information. For example, referring to the first row of the table shown in FIG. 7, bid 506 made by participant P1001 is a bid to purchase five (5) units of the item being auction in auction A1001 (reference to auction database 400 shows that item 1001—laptop computers—are the items being auctioned) at a bid price of $1000/unit.

In some embodiments, there may be more than one current best bid or offer for each auction. For example, in some auctions, a single lot containing multiple items may be offered to multiple buyers. Bid database 500 may also be used to record former current best bids to provide a bid history or audit trail. For example, this information may be used to track the bidding history of different buyers and/or to award units being sold in the auction to a substitute buyer in the case where a current best buyer (or group of current best buyers) is unable to settle their auction trade. In some embodiments, bid database 500 may also be used to record current bids that are not the best bid.

Configuration function 508 may be, for example, the same as or related to one or more configuration function identifiers 402 of transformation database 400. For example, depending on the bid, the participant, and the auction, one or more configuration functions may apply. In the example data shown in FIG. 7, the bid made by participant P1001 is transformed by configuration function identifier F1001 (applying P1001's laptop configuration preferences). The bid made by participant P1004 in auction A1002 is transformed by the configuration function identified by identifier F1005 (applying P1004's desktop computer configuration preference), while the bid made by participant P1002 in auction A1003 is transformed by configuration function F1002 (applying P1002's configuration preference for laptop's sold by participant P1004). In the example date shown in FIG. 7, a single configuration function is associated with each entry. However, in some instances, there may be no configuration function associated with a bid by a participant in an auction, so there would be no entry in configuration function field 508 in bid database 500. In other cases, there may be multiple configuration functions associated with a single bid by a participant in an auction, so there would be multiple entries in configuration function field 508 in bid database 500.

Transformed bid 510 may be, for example, information reflecting bid 506 after application of configuration function 508. In the example data shown in FIG. 7, in the first row, the bid made by participant P1001 (of $1000/unit) has been transformed by applying determining the price differential between the requested configuration and a base configuration. In the example, P1001 has requested a laptop having slightly more expensive components than a base configuration (in the example, the custom configuration is $75 more expensive than the base configuration), therefore, the transformed bid 510 is indicated as being $75 less than the actual bid submitted by P1001. A subsequent bidder who wishes to simply acquire the base configuration will need to submit a bid greater than $925 (in a forward auction format). This transformed bid 510 may be generated by performing a price lookup of price information relating to the auction. Individual components may be priced separately and added or subtracted from the base configuration to arrive at the transformed bid amount.

Current bid information 512, may be, for example, information identifying the current best bid in a particular auction. In a forward sell-side auction, the current best bid is the highest offer received. The best bid in a buy-side auction may be the lowest price offered for an item. Current bid information 512, may be, for example, information identifying a current status of the auction identified by auction identifier 502. The nature and content of this information may depend on the type of auction. For example, in a typical Open cry, forward, sell-side auction, current bid information 512 may include a current high bid amount and a current high bid quantity.

Other information necessary or useful in identifying a current bid status may also be provided in current bid information 512 (e.g., the time of the current bid may also be provided). In one embodiment, this current bid information 512 represents the current bid status at a particular moment in time (e.g., upon receipt and processing of the current bid received by the participant identified by participant identifier 504 in the auction identified by auction identifier 502).

In the data shown in FIG. 7, current bid information 512 reflects the current best bid in the auction. This current bid information 512 may be provided to participants to reflect the current status of the auction (e.g., informing potential participants of the current best bid). In some embodiments, as will be described further below, current bid information 512 may be further transformed before it is communicated to certain participants.

Those skilled in the art will recognize that other types of data may be included in bid database 500. For example, other types of information may be required in different types of auctions. A two-sided auction may require tracking limit orders and may also require tracking the expiration date and time of the limit orders. Other types of auctions may allow submission (and thus require tracking) of bids which are contingent on the occurrence or nonoccurrence of some event. Other systems architectures are possible as well. For example, to improve system response times, historical bid information may be stored in a separate database.

### Process

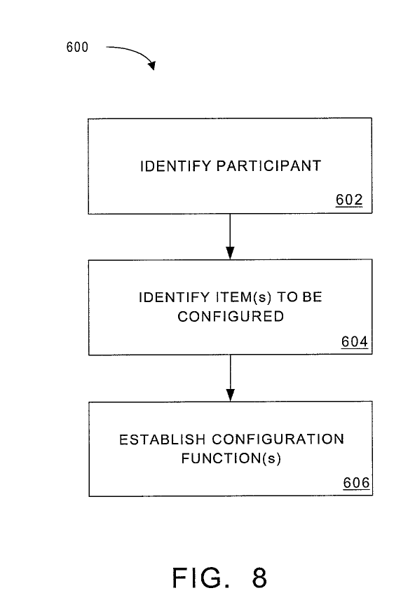

Processes pursuant to embodiments of the present invention will now be described by referring to FIGS. 8-10. In particular, a configuration specification process, a bid process, and a transaction process will be described. In one embodiment, the processes described in FIGS. 8-10 are conducted under the direction of computer program code stored at auction administrator device 16, participant device 12 and/or auction service provider device 24 (or any combination thereof). The particular arrangements of elements in the flow charts of FIGS. 8-10 are not meant to imply a fixed order to the steps; embodiments of the present invention can be practiced in any order that is practicable.

### Configuration Specification Process

Referring now to FIG. 8, a configuration specification process 600 pursuant to one embodiment of the present invention is shown. Configuration specification process 600 may be performed using devices of system 100 (FIG. 3) to establish one or more configuration functions for a participant, so that the participant may take part in auctions conducted using features of the present invention. As an example, process 600 is a configuration specification process for a buyer, involving interaction between a buyer operating buyer device 12a-i and an auction administrator operating auction administrator device 16 via a communication network 18 such as the Internet. As another example, process 600 is a configuration specification process for a seller, involving interaction between a seller operating seller device 12n-z and an auction administrator operating auction administrator device 16.

In some embodiments configuration specification process 600 occurs during a participant registration process. In other embodiments, process 600 is conducted separately to establish configuration functions for particular participants. In some instances, such configuration functions may apply only to a single auction, while in other instances such configuration functions may be utilized in multiple auctions. In some embodiments, process 600 may establish configuration functions that apply to groups or classes of participants, rather than individual participants. In some embodiments, configuration functions established by process 600 apply to all bids made by a participant. In other embodiments, process 600 establishes one or more configuration functions intended for use with one or more particular bids by a participant or set of participants.

Process 600 begins at 602 where the participant is identified. This identification may involve the participant providing information used to populate, for example, participant database 200 (FIG. 4). For example, processing at 602 may involve prompting the participant to enter basic information about itself, including contact information, a participant name, etc.

The participant may be identified by any of a number of other techniques as well. For example, a participant interacting via e-mail may be identified by its e-mail address. A participant interacting via a Web-site may be identified by a user name, and the participant's identity may be authenticated using a password verification process. Participants may also be identified by an identification number, such as an account number, a credit or debit card number, or a social security number. For XML and EDI transactions, the participant could be identified by fields located within XML or EDI messages. Participants interacting via facsimile or telephone may be identified using information about the originating telephone number. Participants could also be identified using cookies stored on a participant device 12.

Once the participant has been identified at 602, processing continues to 604 where one or more item(s) to be configured are identified. Embodiments of the present invention permit a participant to specify a desired configuration for a variety of different types and combinations of goods or services sold at auction. Processing at 602 involves identifying one or more item(s) which will be configured using embodiments of the present invention. In an embodiment where process 600 is performed during an auction registration procedure, processing at 602 may involve referencing auction database 300 (FIG. 5) to identify the item(s) offered in the auction. In other embodiments, processing at 602 may involve prompting the participant to provide information identifying the item(s) for which a configuration function is to be established.

In one embodiment, this information may be solicited using a series of registration questions that are presented to the participant for response. For example, in embodiments where the participant is operating a participant device and interacting with auction administrator device via the Internet, this information may be solicited by presenting the participant with a set of forms for entry and/or a checklist of options that may be selected by the participant. Other methods of soliciting and collecting information may also be used to establish configuration function(s). For example, third party databases may be accessed to collect some information.

Once one or more items to be configured are identified at 604, processing continues to 606 where one or more configuration functions are established. Configuration functions may be established in any of a number of different ways. For example, an auction administrator operating auction administrator device 16 may establish a set list of configuration functions and qualifications for those functions. In such an embodiment, processing at 606 may simply involve matching the established configuration functions with information received at 604 to identify those functions that apply to a particular participant. For example, a configuration function may have been previously established for a participant or for a particular item. The participant may be associated with the previously established configuration function by, for example, storing information that is accessible to auction administrator device 100 that associates the function identifier 402 in configuration function database 400 (FIG. 6) with the participant identifier 202 in participant database 200 (FIG. 4).

In some embodiments, processing at 606 may involve the presentation of a number of different configuration choices to the participant, allowing the participant to select desired configuration choices. For example, if the item being configured is a laptop computer, the participant may be presented with configuration options available for laptop computers (e.g., screen size/type, processor speed/type, storage devices, peripherals, etc.). In some embodiments, the configuration choices may be presented in a manner that ensures that non-compatible configurations are not allowed (e.g., a participant will not be allowed to configure a laptop computer with an internal CD ROM drive if the particular model of laptop in the auction does not have an available internal CD ROM bay). Processing at 606 continues until one or more configuration functions associated with one or more items and the participant are established. The completed configuration function(s) may be associated with the participant by storing configuration rule(s) in participant database 200 and configuration function database 400 (FIGS. 4 and 6, respectively). Those skilled in the art, upon reading this disclosure, will recognize that other techniques may be used to establish configuration functions for use in embodiments of the present invention.

### Bid Process

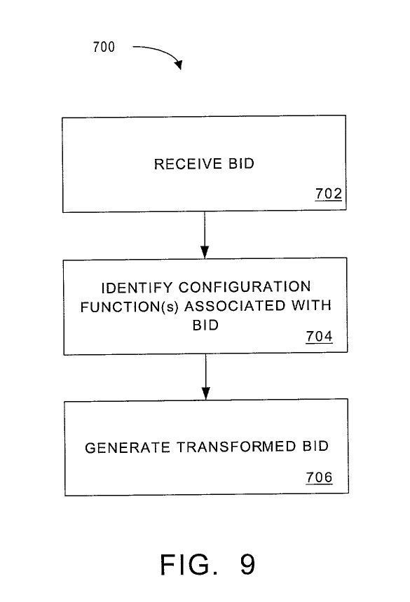

Referring now to FIG. 9, a bid process 700 pursuant to one embodiment of the present invention is shown. In one embodiment, bid process 700 is performed after an auction has been established for one or more items. In one embodiment, a participant may act as a buyer in the auction after one or more configuration functions have been established (e.g., via the configuration specification process 600 described in FIG. 8 above). In some embodiments, not all participants in an auction need to have configuration functions. In some embodiments, bid process 700 and configuration specification process 600 are performed during a single session. In one embodiment, bid process 700 is conducted under the direction of auction administrator device 16.

Processing begins at 702 where a bid is received. In one embodiment, the bid is received by auction administrator device 16 from a buyer operating a buyer device 12a-i. Typically, the bid is received from the buyer after the buyer has had the opportunity to view the terms and conditions of the auction and read a description of the item(s) being offered in the auction. Further, unless the auction is of the sealed bid type or multiple-unit type, the buyer has also typically determined that it is willing to beat the current best bid on the item. In one embodiment, buyer device 12a-i transmits the bid to auction administrator device 16 over a network such as the Internet. Further, in one embodiment, the buyer views information about the auction by directing a Web-browser to an Internet site maintaining information about the auction.

The bid received at 702 may include information identifying the particular auction in which the bid is made, as well as information identifying the item bid on. The bid also typically includes terms of the bid such as a price term, a quantity term, a configuration term, and a delivery term.

Processing continues at 704, where one or more configuration functions associated with the bid received at 702 are identified. In one embodiment, one or more configuration functions are identified by auction administrator device 16 (e.g., by retrieving information contained in, for example, participant database 200, and/or configuration function database 400). A number of different techniques may be used to identify one or more configuration functions associated with a bid

In some embodiments, bids or buyers (or sellers) may be associated with multiple configuration functions. In such cases, the configuration function(s) to be applied may be identified based in part on the other specified configuration function(s). In some embodiments, configuration function(s) to be applied may be applied based on other functions such as transformation functions described in the above-referenced co-pending and commonly-assigned U.S. patent Ser. Nos. _______, _______, _______, _______, _______, _______, (Attorney Docket Nos. I01.050, I01.051, I01.052, I01.053, I01.054 and I01.055, respectively).

In some cases, a configuration function associated with a bid may be identified based on a configuration function associated with a status request by the buyer (e.g., where the bid configuration function is the inverse of the status request configuration function). In some embodiments, a status request configuration function may be identified based on a bid configuration function.

In some embodiments, processing at 704 may involve checking multiple sources to identify relevant configuration function(s). For example, processing at 704 may simply involve a search for configuration functions accessible to auction administrator device 16, or it may involve a search for configuration functions at auction administrator device 16, participant device 12 and/or auction service provider device 24. Other sources of configuration functions may also be provided.

Once one or more configuration functions have been identified at 704, processing continues at 706 where a transformed bid is generated. This transformation may involve applying one or more configuration functions to the bid received at 702. In some embodiments, generation of the transformed bid may require reference to extrinsic data. For example, a configuration function that is established based on product costs, component or raw material costs, or other outside factors may require reference to external data and/or databases. This reference may be performed in conjunction with processing at 706.

Once the bid has been transformed, the transformed bid is presented to the auction as the buyer's bid. The transformed bid is then considered pursuant to the auction rules. For example, in a forward English auction, the transformed bid will be compared with the current best bid to determine if the transformed bid is greater than the current best bid. If it is, then the transformed bid becomes the auction's current best bid, and any subsequent bid must be greater than the transformed bid to be successful. In this manner, embodiments of the present invention permit a buyer's special circumstance (e.g., the buyer's desired item configuration) to be factored into the buyer's bid.

### Transaction Process

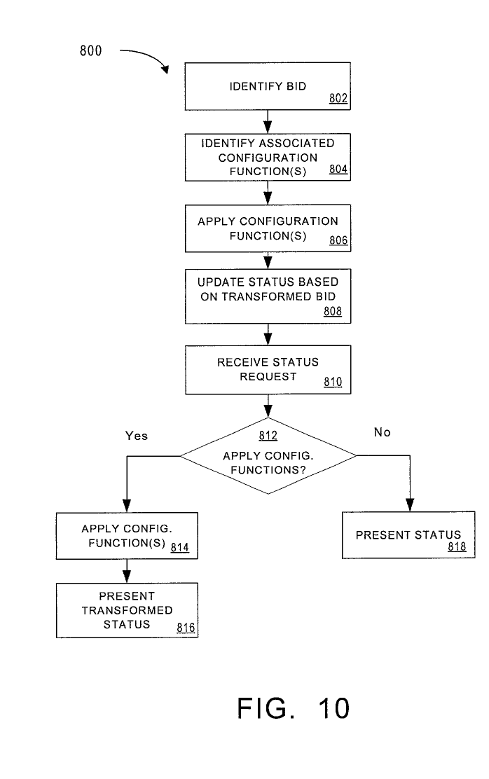

Referring now to FIG. 10, an example transaction process 800 pursuant to an embodiment of the present invention is shown. Transaction process 800 depicts a typical process that may occur in auctions implementing features of the present invention. Process 800 describes a process where one participant in an auction submits a bid and the bid is transformed and used to update a status of the auction. A second participant then checks the status of the auction. The auction status may then be transformed for viewing by the second participant.

Transaction process 800 begins at 802 where a bid is identified. For example, at 802, auction administrator device 16 (FIG. 1) may receive a bid on an item in an auction from a buyer operating a buyer device 12. The bid identified at 802 may include information identifying the particular auction in which the bid is submitted, the buyer (or seller), as well as bid information such as a bid price and a bid quantity, etc.

At 804, processing determines whether a configuration function is associated with the buyer (or the bid, the auction, or other information associated with the bid) who submitted the bid identified at 802. According to embodiments of the present invention, certain configuration functions may be identified based on an identity of the buyer. For example, a particular buyer may have established (e.g., in a configuration function specification process 600 as described above) a configuration function to be applied to all bids made by the participant in the particular auction or for the particular item being bid upon. If processing at 804 indicates that one or more configuration functions exist which should be applied to the particular bid, identified at 802, processing continues to 806 where the configuration function is applied to the bid. For example, if the participant is participant P1001 in the example data, and is bidding on a laptop computer offered in auction A1001, application of the configuration function at 806 will result in a transformed bid that identifies P1001's desired configuration. In some embodiments, processing at 806 may involve referencing pricing information to calculate a transformed bid price based on the desired configuration. In one embodiment, this pricing is based on a reference price (e.g., the price of a standard configuration item).

Processing continues at 808 where a status of the auction is updated based on the transformed bid. Depending on the nature of the configuration function(s) identified at 804 and applied at 806, the transformed bid may be significantly different than the original bid identified at 802. In some embodiments, the transformed bid may be slightly changed (or even remain unchanged) from the original bid identified at 802. According to embodiments of the present invention, this process and use of a transformed status allows participants to compete in the same auction despite having different configuration desires.

In a typical auction, once a bid has been received and the auction status has been updated to reflect the current best bid, other potential buyers and participants in the auction will request a status of the auction. This remains unchanged in auctions conducted pursuant to embodiments of the invention. As shown in FIG. 10, a status request is received at 810. Unlike previous auctions, however, processing pursuant to embodiments of the present invention includes a determination at 812 of whether configuration function(s) should be applied to generate a transformed status of the auction. According to embodiments of the present invention, the status of the auction may be transformed based on configuration function(s) associated with a participant requesting the auction status to present a transformed status to some participants. Other participants may view non-transformed status.

According to some embodiments of the present invention, processing at 812 includes making a determination of whether one or more configuration function(s) should be applied to the auction status to generate a transformed status for the requesting participant. This determination may occur in any of a number of ways. For example, in some embodiments, the status request received at 810 may include an identification of the participant requesting the status. This information may be used to determine if a configuration function should be applied. Further, information about the auction and the item(s) being auctioned may also be used to determine if a configuration function should be applied.

As an example, referring to participant database 200 (FIG. 4), if participant P1001 is the participant requesting status at 810, processing at 812 may involve a search of participant database 200 which will identify that participant P1001 is associated with configuration functions F1001 (“P1001 Custom Laptop”).

Once a determination has been made that transformation(s) of the status are required, processing continues to 814 where the identified configuration function(s) are applied to the status. In the example where participant P1001 issues the status request, processing at 814 involves applying configuration function F1001 to the current status of the auction. If the current status of the auction is that the current best bid is a $1,000 bid for a standard-configuration laptop computer, then the transformed status generated at 814 will be that the current best bid is a $1,075 bid (where the extra $75 represents the extra cost of the laptop configured as specified by P1001 in configuration function F1001). This transformed status is presented to the requesting party at 816. Presentation of the transformed status may be accomplished in any of a number of different ways such as, for example using XML or EDI transactions, instant messaging, e-mail, a Web-page, a telephone, facsimile, telex, etc.

In some embodiments of the present invention, only the transformed status will be presented to the buyer or seller at 816. In other embodiments, however, both the transformed status and the untransformed status may be presented. In yet other embodiments, the transformed status may be presented in conjunction with a partially transformed status reflecting transformation by only a subset of the configuration functions that apply to the status request. In some embodiments, information about the configuration function applied to the status request is presented to the participant, while in other embodiments, no information about the configuration function applied to the status request is presented to the participant. In yet other embodiments, various combinations of transformed, partially transformed, or untransformed status information is presented, with or without information about the associated configuration functions.

If processing at 812 indicates that no transformation of status is required (e.g., where the requesting participant does not have an associated configuration function or other transformation function), processing continues to 818 where the status is presented to the requestor. This non-transformed status may be presented in any of a number of different ways, such as, for example, using XML or EDI transactions, instant messaging, e-mail, a Web-page, a telephone, facsimile, telex, etc.

According to embodiments of the invention, transaction process 800 may be performed a number of times during an auction. The result is a system that allows personalization of bids (including offers to purchase and offers to sell), and auction status information based on each participant's particular situation. As a result, differently-situated participants may take part in a single auction, with the bidding in the auction and presentation of auction status transformed to reflect their particular situations. In particular, embodiments of the present invention permit participants to bid on goods or services that are specially configured for each participant.

Although the present invention has been described with respect to a preferred embodiment thereof, those skilled in the art will note that various substitutions may be made to those embodiments described herein without departing from the spirit and scope of the present invention. The particular configuration functions specified and described herein have been selected for clarity of exposition, and do not represent all possible transformations. The stage at the auction process during which configuration functions are associated or bound with a bid or buyer or seller submitting the bid, or other entity as specified and described herein have been selected for clarity of exposition, and do not represent all possible auction stages when transformations could be associated or bound.

The manner in which configuration functions are associated with a bid or buyer or seller submitting the bid, or other entity, as specified and described herein have been selected for clarity of exposition, and do not represent all possible manners by which transformations could be associated or bound. Those skilled in the art will also note that although embodiments of the present invention have been described in the context of an auction or marketplace, certain features or embodiments may also apply to other forms of commerce and electronic commerce, including electronic negotiation, combinations of auctions and electronic negotiation, and various forms of interactions between and among various agents, including business entities, individuals, data processing systems, auctions, marketplaces, and intelligent software agents.

What is claimed is:

1. A method for facilitating the sale of an item in an auction involving a plurality of participants, comprising:
identifying a bid for said item, said bid made by one of said participants;
identifying a desired configuration associated with said bid;
modifying said bid to reflect said desired configuration; and
updating a status of said auction based on said modified bid.

2. The method of claim 1, wherein said bid is an offer to purchase said item.

3. The method of claim 1, wherein said bid is an offer to sell said item.

4. The method of claim 1, further comprising:
generating status data representing said status of said auction; and
presenting said status data to said plurality of participants.

5. The method of claim 1, further comprising:
receiving an auction status request;
identifying, based at least in part on said auction status request, a second desired configuration; and
applying said second desired configuration to said status to produce a transformed status.

6. The method of claim 5, wherein said status request is received from one of said participants.

7. The method of claim 6, wherein said second desired configuration is identified based on an identity of said participant.

8. The method of claim 5, wherein said transformed status indicates at least one of: an amount which is different than an amount indicated by said status data; auction information identical to said status data; and auction information different than said status data.

9. The method of claim 1, wherein said item is plurality of goods.

10. The method of claim 1, wherein said item is a plurality of goods and services.

11. The method of claim 1, wherein said item is an item having at least one configurable element.

12. The method of claim 11, wherein said desired configuration specifies a desired configuration based on said configurable element.

13. The method of claim 1, wherein said desired configuration is specified by at least one of a buyer, a seller, an auction service provider, and an auction administrator.

14. The method of claim 1, wherein said desired configuration is specified by at least one of said participants by presenting said at least one of said participants with a plurality of options for said item and receiving information identifying said desired configuration of said item.

15. The method of claim 1, wherein said desired configuration is specified prior to said auction.

16. The method of claim 1, wherein said desired configuration is specified during said auction.

17. The method of claim 1, wherein said modifying said bid further comprises:
comparing said desired configuration with price information to determine a price differential; and
combining said price differential with a bid price to generate said modified bid.

18. The method of claim 17, wherein said price information is determined based on at least one of: a price table for said item; an algorithm; and a formula.

19. The method of claim 1, further comprising:
binding said modified bid as the winning bid if said modified bid is the best bid of said auction at a closing of said auction.

20. An auction method, comprising:
presenting item configuration options to a participant;
receiving information identifying a desired configuration;
associating said desired configuration with said participant;
receiving a bid on said item from said participant;
modifying said bid to reflect said desired configuration; and
updating a status of said auction based on said modified bid.

21. The auction method of claim 20, wherein said modifying said bid further comprises:
calculating a price differential between a standard configuration of said item and said desired configuration; and
modifying said bid based on said price differential.

22. The auction method of claim 20, further comprising:
receiving a request for said status of said auction from a second participant;
identifying a second desired configuration associated with said second participant;
modifying said status of said auction based on said second desired configuration; and
presenting said modified status to said second participant.

23. The auction method of claim 22, wherein said modifying said status further comprises:
calculating a price differential between said modified bid and said second desired configuration; and
modifying said status based on said price differential.

24. A method for participating in an auction, comprising:
indicating a preferred configuration of an item offered in said auction;
viewing a status of said auction, said status modified based on said preferred configuration; and
submitting a bid on said item, said bid modified based on said preferred configuration.

25. A system for facilitating the sale of an item in an auction involving a plurality of participants, comprising:
means for identifying a bid for said item, said bid made by one of said participants;
means for identifying a desired configuration associated with said bid;
means for modifying said bid to reflect said desired configuration; and
means for updating a status of said auction based on said modified bid.

26. An auction device, comprising:
a processor;
a communication device, in communication with said processor, receiving a bid for an item in an auction, said bid received from a buyer device;
a memory unit in communication with said processor and storing a program, wherein said processor is operative with said program to
identify a desired configuration associated with said bid;
modify said bid to reflect said desired configuration; and
update a status of said auction based on said modified bid.

27. A computer-readable medium having computer-executable instructions for performing steps, comprising:
identifying a bid for an item in an auction, said bid made by a participant in said auction;
identifying a desired configuration associated with said bid;
modifying said bid to reflect said desired configuration; and
updating a status of said auction based on said modified bid.
